(19) United States
(12) Patent Application Publication
(10) Pub. No.: US 2025/0240337 A1
(43) Pub. Date: Jul. 24, 2025

(54) METHODS AND SYSTEMS FOR AUTOMATING CONNECTION TO A COLLABORATIVE SOFTWARE PLATFORM

(71) Applicant: ScreenBeam Inc., San Jose, CA (US)

(72) Inventors: Chuong VU, Cupertino, CA (US); Dean CHANG, San Jose, CA (US); Chuang LI, Saratoga, CA (US)

(73) Assignee: ScreenBeam Inc., San Jose, CA (US)

(21) Appl. No.: 19/031,049

(22) Filed: Jan. 17, 2025

Related U.S. Application Data
(60) Provisional application No. 63/622,823, filed on Jan. 19, 2024.

(51) Int. Cl. H04L 65/403; G06F 3/14; H04L 67/141

(52) U.S. Cl. CPC H04L 65/403; G06F 3/14; H04L 67/141

(57) ABSTRACT

Systems and methods are provided for automating connection to a collaborative software platform. The systems and methods may include receiving roster data including a first moderator identifier and participant identifiers as well as receiving a request to access the roster data, which may include a second moderator identifier corresponding to the moderator device. The moderator device may be permitted to access to the roster data based on the first moderator identifier being the same as the second. Another request to connect a set of participant devices corresponding to a set of participant identifiers to a collaboration session and a session key may then be received from the moderator device and it may be determined that the set of participant identifiers corresponds to the participant identifiers in the roster data. Each participant device may connect to the collaboration session using the session key and may be caused to display media content.

### CROSS-REFERENCE TO RELATED APPLICATIONS

This application claims priority to U.S. Provisional Application Ser. No. 63/622,823, filed Jan. 19, 2024, the entire contents of which are incorporated herein by reference.

### TECHNICAL FIELD

The present disclosure relates, in general, to collaborative software platforms, and, more particularly, to methods and systems for automating connection to collaborative software platforms and/or secondary software.

### BACKGROUND

Users in academic, professional, recreational, and other settings have become increasingly reliant upon collaborative technologies to facilitate the sharing of ideas, data, communications, and the like amongst one another. As an evermore disparate array of such collaborative technologies are introduced to market by various parties and developers, users—both moderators and participants—are likely to experience frustration due to a lack of tight integration from one collaborative technology to another. Indeed, issues such as inefficient means of connection to collaborative platforms (or lack of connectivity altogether), lag and latency issues, and inability to adequately govern participant access to, or participation in, collaboration sessions may even cause users to abandon otherwise promising collaborative technologies altogether.

In the modern classroom, for example, classroom orchestration may involve the use of touch displays with interactive or collaborative whiteboard capabilities, laptops or tablets for teachers and students, learning management systems, and educational software, just to name a few of many potential collaborative technologies. In moderating classroom sessions, teachers may use these and other tools to enhance instructions, facilitate collaboration, and monitor students' progress in their lessons.

A significant issue for teachers involves the need to manage disparate educational technologies over the course of a teaching session. For example, in order to monitor students' activities on their respective laptops, tablets, or other connected computing devices, a teacher must typically employ a software application hosted on the internet. To use an interactive whiteboard, meanwhile, the teacher will likely need to launch a whiteboard application on a touch display at the front of the classroom. Further still, in order to share material from the teacher's own computer, the teacher may need to launch a wireless display application and thereby connect to the front-of-room display.

Collaborative whiteboard technology provides one of many examples of the inherent inefficiencies in existing educational and collaborative technologies. In order to use a collaborative whiteboard technology such as the Microsoft® Whiteboard application, the teacher must first launch the collaborative whiteboard application on his or her laptop, tablet, etc. Second, the teacher must create a collaborative whiteboard session. Third, the teacher must instruct the students to launch the same collaborative whiteboard application on their respective laptops, tablets, etc. Fourth, the teacher must provide the students with a session key such as a unique identifier (ID) or Uniform Resource Locator (URL) corresponding to the collaborative whiteboard session. Fifth, and—hopefully—finally, each student must input the session key into his or her respective collaborative whiteboard application. Of course, technical difficulties or connectivity issues might require the teacher to further assist some students in joining the collaborative whiteboard session, forcing the teacher to waste valuable time away from teaching.

In this and many other examples, lack of tight integration between disparate educational and collaborative technologies presents an inherently inefficient use of the teacher's time. A frustrating or unwieldy user experience may ultimately cause the teacher to abandon the educational and collaborative technologies altogether. Although many of these issues and challenges are presented herein with respect to a classroom setting, it will be understood that such issues and challenges are not necessarily unique to the classroom setting. Indeed, similar concerns exist for users of collaborative technologies in professional, recreational, and many other collaborative environments.

As such, there is a need for improved methods for connecting to collaborative software platforms and/or secondary software, including methods for automating such connections. For example, there is a need for improved methods for integrating collaborative technologies such as wireless display technology, interactive or collaborative whiteboard technology, and/or technology for monitoring participants' activities on their respective laptops, tablets, etc., in order to provide a seamless user experience and increase efficiency during collaboration sessions. Moreover, there is a need for such methods to incorporate improved roster management to facilitate appropriate access for moderators and participants in such collaboration sessions. Further, there is an associated need for systems and devices designed to facilitate improved connectivity to such collaborative software platforms and/or secondary software by integrating disparate collaborative technologies in a more streamlined manner.

### SUMMARY OF THE INVENTION

The present disclosure is directed to methods and systems for automating connection to a collaborative software platform and/or secondary software. For example, the systems and methods may include receiving roster data including a first moderator identifier and participant identifiers as well as receiving a request to access the roster data, which may include a second moderator identifier corresponding to the moderator device. The moderator device may be permitted to access to the roster data based on the first moderator identifier being the same as the second moderator identifier. Another request to connect a set of participant devices corresponding to a set of participant identifiers to a collaboration session and a session key may then be received from the moderator device and it may be determined that the set of participant identifiers corresponds to the participant identifiers in the roster data. Each participant device may then connect to the collaboration session using the session key and may be caused to display media content

A method is provided herein for automating connection to a collaborative software platform, the method comprises establishing, by a computing device, a connection with a display device, receiving roster data associated with at least one moderator identifier and including a plurality of participant identifiers, the at least one moderator identifier including a first moderator identifier, receiving a first request to access the roster data from a moderator device, the first request including a second moderator identifier corresponding to the moderator device, permitting the moderator device access to the roster data based on the first moderator identifier being the same as the second moderator identifier, receiving, from the moderator device, a second request to connect a set of participant devices corresponding to a set of participant identifiers to a collaboration session on the collaborative software platform and a session key corresponding to the collaboration session, determining the set of participant identifiers corresponds to the plurality of participant identifiers in the roster data, causing each participant device of the set of participant devices corresponding to the set of participant identifiers to connect to the collaboration session using the session key, and causing each participant device of the set of participant devices to display media content corresponding to the collaboration session on a respective participant device, wherein the display device and the moderator device are connected to the collaboration session and each display the media content corresponding to the collaboration session.

The method may include permitting the moderator device moderator access to the collaboration session, and permitting each participant device of the set of participant devices access to the collaboration session, the participant access granting, relative to the moderator access, restricted control of the collaboration session. Displaying the media content on the display device may be based at least in part on the moderator access and the participant access. The method may include receiving, from the moderator device, a third request to modify at least one restriction associated with the participant access for at least a first participant device of the one or more participant devices connected to the collaboration session. At least a portion of the media content may be generated by the first participant device. The method may include causing the moderator device to display the portion of the media content generated by the first participant device, and causing the display device to display the portion of the media content generated by the first participant device. The method may include receiving, from the moderator device, a third request to connect one or more additional participant devices to the collaboration session, the one or more additional participant devices not corresponding to the roster data, causing each additional participant device of the one or more additional participant devices to connect to the collaboration session using the session key, and causing each additional participant device of the one or more additional participant devices to display the media content corresponding to the collaboration session.

The method may include updating the roster data based on the third request to connect the one or more additional participant devices to the collaboration session. Causing each participant device of the set of participant devices to connect to the collaboration session using the session key may include transmitting a fourth request to execute a software application installed on each participant device of the set of participant devices, and causing each participant devices of the set of participant devices to execute the software application using the session key.

The method may include detecting a disconnection of the moderator device from the collaboration session, and causing the set of participant devices to disconnect from the collaboration session based on detecting the disconnection of the moderator device from the collaboration session. The roster data may be received from a server connected to the computing device. The method may include removing, prior to receiving the roster data associated with the first moderator identifier and including the plurality of participant identifiers, personal information associated with a moderator and a plurality of participants corresponding, respectively, to the first moderator identifier and the plurality of participant identifiers.

A system is provided herein for automating connection to a collaborative software platform. The system may include memory configured to store computer-executable instructions, and at least one computer processor configured to access memory and execute the computer-executable instructions to establish, by a computing device, a connection with a display device, receive roster data associated with at least one moderator identifier and including a plurality of participant identifiers, the at least one moderator identifier including a first moderator identifier, receive a first request to access the roster data from a moderator device, the first request including a second moderator identifier corresponding to the moderator device, permit the moderator device access to the roster data based on the first moderator identifier being the same as the second moderator identifier, receive, from the moderator device, a second request to connect a set of participant devices corresponding to a set of participant identifiers to a collaboration session on the collaborative software platform and a session key corresponding to the collaboration session, determine the set of participant identifiers corresponds to the plurality of participant identifiers in the roster data, cause each participant device of the set of participant devices corresponding to the set of participant identifiers to connect to the collaboration session using the session key, and cause each participant device of the set of participant devices to display media content corresponding to the collaboration session on a respective participant device, wherein the display device and the moderator device are connected to the collaboration session and each display the media content corresponding to the collaboration session.

The at least one computer processor may be further configured to access memory and execute the computer-executable instructions to permit the moderator device moderator access to the collaboration session, and permit each participant device of the set of participant devices access to the collaboration session, the participant access granting, relative to the moderator access, restricted control of the collaboration session. Displaying the media content on the display device may be based at least in part on the moderator access and the participant access. The at least one computer processor may be further configured to access memory and execute the computer-executable instructions to receive, from the moderator device, a third request to modify at least one restriction associated with the participant access for at least a first participant device of the one or more participant devices connected to the collaboration session. At least a portion of the media content is generated by the first participant device and wherein the at least one computer processor is further configured to access memory and execute the computer-executable instructions to cause the moderator device to display the portion of the media content generated by the first participant device, and cause the display device to display the portion of the media content generated by the first participant device.

The at least one computer processor may be further configured to access memory and execute the computer-executable instructions to receive, from the moderator device, a third request to connect one or more additional participant devices to the collaboration session, the one or more additional participant devices not corresponding to the roster data, cause each additional participant device of the one or more additional participant devices to connect to the collaboration session using the session key, and cause each additional participant device of the one or more additional participant devices to display the media content corresponding to the collaboration session. The at least one computer processor may be further configured to access memory and execute the computer-executable instructions to update the roster data based on the third request to connect the one or more additional participant devices to the collaboration session.

Causing each participant device of the set of participant devices to connect to the collaboration session using the session key may further include transmitting a fourth request to execute a software application installed on each participant device of the set of participant devices, and causing each participant devices of the set of participant devices to execute the software application using the session key. The at least one computer processor may be further configured to access memory and execute the computer-executable instructions to detect a disconnection of the moderator device from the collaboration session, and cause the set of participant devices to disconnect from the collaboration session based on detecting the disconnection of the moderator device from the collaboration session. The roster data may be received from a server connected to the computing device. The at least one computer processor may be further configured to access memory and execute the computer-executable instructions to remove, prior to receiving the roster data associated with the first moderator identifier and including the plurality of participant identifiers, personal information associated with a moderator and a plurality of participants corresponding, respectively, to the first moderator identifier and the plurality of participant identifiers.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIGS. 1-4 are diagrams illustrating example collaborative systems and devices in accordance with aspects of the present invention.

FIG. 5 is a flowchart illustrating example steps for automatically connecting to a collaborative software platform in accordance with principles of the present invention.

FIG. 6 is a flowchart illustrating example steps for manually connecting to a collaborative software platform in accordance with principles of the present invention.

FIG. 7 is a flowchart illustrating example steps for automating connection to collaborative software in accordance with principles of the present invention.

### DETAILED DESCRIPTION OF THE INVENTION

Methods and systems for automating connection to a collaborative software platform and/or secondary software have been developed. A method for automating connecting to a collaborative software platform may include: establishing, by a computing device, a connection with a display device; receiving roster data associated with a first moderator identifier and including a plurality of participant identifiers; receiving a first request to access the roster data from a moderator device, the first request including a second moderator identifier corresponding to the moderator device; permitting the moderator device access to the roster data based on the first moderator identifier being the same as the second moderator identifier; receiving, from the moderator device, a second request to connect a set of participant devices corresponding to a set of participant identifiers to a collaboration session on the collaborative software platform and a session key corresponding to the collaboration session; determining the set of participant identifiers corresponds to the plurality of participant identifiers in the roster data; causing each participant device of the set of participant devices corresponding to the set of participant identifiers to connect to the collaboration session using the session key; and causing each participant device of the set of participant devices to display media content corresponding to the collaboration session on a respective participant device. The display device and the moderator device may be connected to the collaboration session and may each display the media content corresponding to the collaboration session.

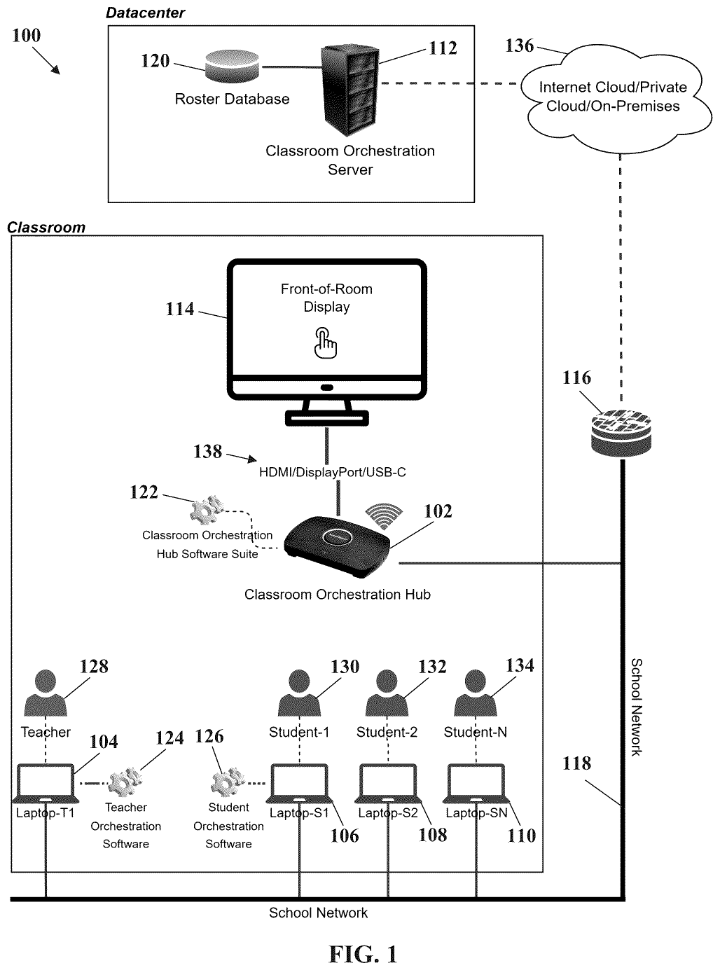

Referring now to FIG. 1, an example collaborative system is illustrated. As shown in FIG. 1, and in brief overview, system 100 may include hub device 102, moderator device 104, participant device 106, participant device 108 through participant device 110, server 112, display device 114, and/or router 116. Users of system 100 may include moderator 128 (via moderator device 104), participant 130 (via participant device 106), and/or participant 132 through participant 134 (via participant device 108 through participant device 110).

As depicted in FIG. 1, a collaborative setting in which system 100 may be implemented may be a classroom. Accordingly, moderator 128 may be a teacher, while participant 106 and participant 108 through participant 110 may be students. It will, however, be understood that system 100 may be implemented in any collaborative setting, including but not limited to various academic, professional, and recreational environments in which collaboration amongst users via collaborative technologies may be desired or appropriate.

Hub device 102 may be a hardware device capable of running hub software 122. Hub device 102 may serve as a communication hub within a collaborative setting for facilitating streamlined and efficient communication between moderator device 104 and each of participant device 106 and participant device 108 through participant device 110. A multi-protocol (e.g., Miracast®, Apple® AirPlay®, Google® Chromecast®, and/or any other proprietary wireless display protocol) wireless display receiver (not shown) may be integrated into hub device 102 and may include Wi-Fi® and/or Bluetooth® Low Energy interface modules. At its core, hub device 102 may include a multimedia and network system-on-chip (SoC). The SoC may further include a graphics processing unit (GPU) and/or one or more dedicated audio codecs (e.g., linear pulse-code modulation (LPCM) and/or Advanced Audio Coding (AAC)) or video codecs (e.g., H.264, H.265, AOMedia Video 1 (AV1), VP9, and/or VP10) to support various audio- or video-streaming applications that may be integrated into system 100. Hub device 102 may be connected to display device 114 via HDMI, DisplayPort, or USB cable or via any other wired or wireless connection (e.g., connection 138). Hub device 102 may be connected to network 118 via wired (e.g., Ethernet) or wireless (e.g., Wi-Fi) connection.

Hub software 122 may be a suite of software including one or more programs or applications executable on hub device 102. For example, hub software 122 may include a wireless display server, an interactive or collaborative whiteboard application, screen-sharing gatekeeper and/or monitoring applications, and/or any other software program or application for use in a collaborative environment. Hub software 122 may include any combination of proprietary, secondary, or third-party collaborative software and/or may include one or more modules for communicating with external secondary or third-party collaborative software applications as part of a collaborative software platform or system. It will be understood that reference to a collaborative software platform may consider any such combination of integral and/or external software architectures. Hub software 122 may include one or more modules for communicating with corresponding modules of moderator software 124 and/or participant software 126, which may be installed, respectively, on moderator device 104 and/or any of participant device 106 or participant device 108 through participant device 110. Accordingly, hub device 102 may facilitate use of various collaborative technologies in a collaboration session involving moderator 128, participant 130, and/or participant 132 through participant 134.

For example, the respective participant devices connected to system 100 may, by default, be blocked from sharing content from their respective screens on display device 114 by a screen-sharing gatekeeper application installed on hub device 102. An authorized client application such as moderator software 124 installed on moderator device 104 may, however, be able to send commands to a module installed on hub device 102 to enable one or more of the connected participant devices to share content from their respective screens on display device 114 as moderator 128 deems appropriate.

Alternatively, or in addition, an authorized client application (e.g., moderator software 124) may be able to send commands to a module installed on hub device 102 to enable monitoring functionality for controlled screen-sharing. When such monitoring functionality is enabled, hub device 102 may continue to receive screen-shared content from one or more participant devices. However, prior to the hub device 102 causing such content to be displayed on display device 114, hub device 102 may await instructions from moderator device 104 indicating that moderator 128 has approved the content for screen-sharing. Correspondingly, a module of hub device 102 may duplicate the content that is pending approval from moderator 128 and transmit the duplicated content to moderator software 124 for display and review by moderator 128 on moderator device 104.

Digital inking may be supported in conjunction with monitoring functionality of a screen-sharing application enabled by hub device 102. For example, when any participant annotates content on the screen of his or her respective participant device, a digital ink trace of the annotated content may be shown on display device 114 and on moderator device 104. When moderator 128 annotates content on display device 114, a digital ink trace of the annotated content may be shown on display 114, moderator device 104, and each respective participant device.

Hub device 102 may integrate a collaborative whiteboard software application for use within the collaborative setting. For example, when moderator 128 uses moderator software 124 installed on moderator device 104 to launch a collaborative whiteboard session, the whiteboard may be shown on display device 114. Each participant device connected to network 118 may be caused to automatically join the collaborative whiteboard session to facilitate collaboration between moderator 128 and each corresponding participant in the collaborative environment.

Display device 114 may be any display device designed for use in a collaborative system such as system 100. For example, display device 114 may include touch-display capabilities, “smart” functionality, and/or one or more wired or wireless connections for communication with various other devices of system 100. Display device 114 may be an off-the-shelf display device or may integrate one or more proprietary functions of the collaborative systems described or envisioned throughout the present disclosure.

Moderator device 104 may be a computing device (e.g., laptop, tablet, or desktop computer) capable of running moderator software 124. Moderator device 104 may be used by moderator 128 within the collaborative setting in which system 100 may be implemented. Moderator device 104 may be connected to network 118 via wired or wireless connection and may thereby communicate with hub device 102, participant device 106, participant device 108 through participant device 110, router 116, and/or any other device connected to network 118. Moderator software 124 may provide moderator 128 with a unified and user-friendly user interface (UI) designed for moderator 128 to use any collaborative technology integrated into system 100 (e.g., wireless display technology, interactive or collaborative whiteboard technology, and/or classroom management technology). For example, the UI of moderator software 124 may enable moderator 128 to execute local instances of any such collaborative technology on moderator device 104 and/or facilitate remote access (e.g., via network 118) to one or more collaborative technologies executed locally on hub device 102, server 112, or any other computing device associated with system 100.

Participant device 106 and/or participant device 108 through participant device 110 may each be a computing device (e.g., laptop, tablet, or desktop computer) capable of running a respective instance of participant software 126. Participant device 106 and/or participant device 108 through participant device 110 may be used, respectively, by participant 130 and/or participant 132 through participant 134 within the collaborative setting in which system 100 may be implemented. Participant device 106 and/or participant device 108 through participant device 110 may each be connected to network 118 via wired or wireless connection and may thereby communicate with hub device 102, any other participant devices, router 116, and/or any other device connected to network 118.

Participant software 126 may provide participant 130 and/or participant 132 through participant 134 with streamlined, moderated, and/or user-friendly access to any of the collaborative technologies integrated into system 100, which may be in accordance with the preferences of moderator 128. For example, participant software 126 may execute instructions to automatically connect each of participant device 106 and participant device 108 through participant device 110 to an active collaboration session initiated from moderator device 104. Once each respective participant device has been connected to the collaboration session, the respective participant device may receive and/or execute instructions transmitted from moderator device 104 via communications between moderator software 124 and the respective instance of participant software 126. For example, per instructions received from moderator 128 via moderator device 104, participant device 106 might auto-initiate sharing of media content displayed on participant device 106 with display device 114 and/or auto-launch an interactive or collaborative whiteboard application installed on participant device 106 or otherwise remotely accessible and join a collaborative whiteboard session initiated by moderator 128. Alternatively, or in addition, participant software 126 might permit moderator 128 to remotely monitor activity on participant device 106 via moderator device 104 (e.g., by communicating with moderator software 124). As with moderator software 124, participant software 126, may enable each respective participant to executive local instances of any collaborative technology associated with system 100 on the respective participant device and/or facilitate remote access (e.g., via network 118) to one or more collaborative technologies executed locally on hub device 102, moderator device 104, server 112, or any other computing device associated with system 100.

It will be understood that hub software 122, moderator software 124, and/or participant software 126 may or may not each include the same suite of software programs, applications, and/or modules. For example, hub software 122, moderator software 124, and participant software 126 may each be the same software installed on a different device, the respective functionality of each instance of the software based on user credentials input prior to use of the software and/or the respective device on which the software is being run. Alternatively, hub software 122, moderator software 124, and/or participant software 126 may each be different software including cross-compatible modules for communications between one another.

Server 112 may exist on cloud 136 (e.g., internet cloud or private cloud) or may be physically located on- or off-premises relative to the collaborative environment. Router 116 may facilitate communication between any of server 112, cloud 136, and/or network 118. Server 112 may be used to store roster database 120, which may include roster data corresponding to moderator 128, participant 130, and/or participant 132 through participant 134. A function of server 112 may be to connect moderators (e.g., moderator 128) and participants (e.g. participant 130 and/or participant 132 through participant 134) when, for example, moderator 128 in a collaborative setting starts a collaboration session by connecting moderator device 104 to hub device 102. Server 112 may refer to roster data stored on roster database 120 in automatically directing the respective participant devices (e.g., participant device 106 and/or participant device 108 through participant device 110) of appropriate participants (e.g. participant 130 and/or participant 132 through participant 134) to also connect to hub device 102 such that any collaborative technology connected to hub software 122 may be collectively utilized by all users within the collaborative setting.

Roster database 120 may store a minimum amount of personal information corresponding to each of moderator 128, participant 130, and/or participant 132 through participant 134 necessary to ensure appropriate moderator and/or participant access to a collaboration session within the collaborative setting. For example, roster data stored on roster database 120 may simply indicate that moderator 128 is responsible for moderating a particular session (e.g., a teacher being responsible for teaching a particular class) and that each of participant 130 and participant 132 through participant 134 is a participant in that session (e.g., students being enrolled in the aforementioned teacher's class).

Administrative or information technology (IT) personnel associated with the collaborative setting may be responsible for maintaining accurate and up-to-date roster data in roster database 120. For example, roster database 120 may include a mechanism to import roster data from an external data source associated with the collaborative setting (e.g., student enrollment information maintained in a corresponding enrollment system by school administrators). Roster data may, for instance, be stored in a data format such as the OneRoster format developed by IMS Global® Learning Consortium or any other format supported by system 100. Server 112 may support an application programing interface (API) such as Representative State Transfer (REST) for importing roster data. The administrative or IT personnel may write a script in any scripting language (e.g., Python) to read the roster data and call a Roster-Database-Update REST API to populate roster database 120.

For example, the administrative or IT personnel may export the roster data in OneRoster format from a student information system (SIS) associated with the collaborative setting and upload the corresponding OneRoster files to a shared folder. Once the OneRoster files have finished uploading, a program may be caused to run. The program may read the OneRoster files and feed the corresponding new roster data to server 112 using the Roster-Database-Update REST API. Accordingly, the administrative or IT personnel for each collaborative setting (e.g., school or workplace) may be responsible for defining roster-update and data-privacy policies as appropriate for their particular setting.

Such processes associated with updating or maintaining roster database 120 may facilitate protection and safeguarding of personal information and data privacy in accordance with laws or regulations that may govern the collaborative setting. For example, certain personal information may be “scrubbed” from the roster data prior to its upload to roster database 120 on server 112. Scrubbing the roster data in this manner may prevent unpermitted access to personal information of moderators or participants in the collaborative setting by third-party applications associated with various collaborative technologies integrated into system 100. Server 112 may further be designed to protect the roster data using encryption of such data both at rest and in transit.

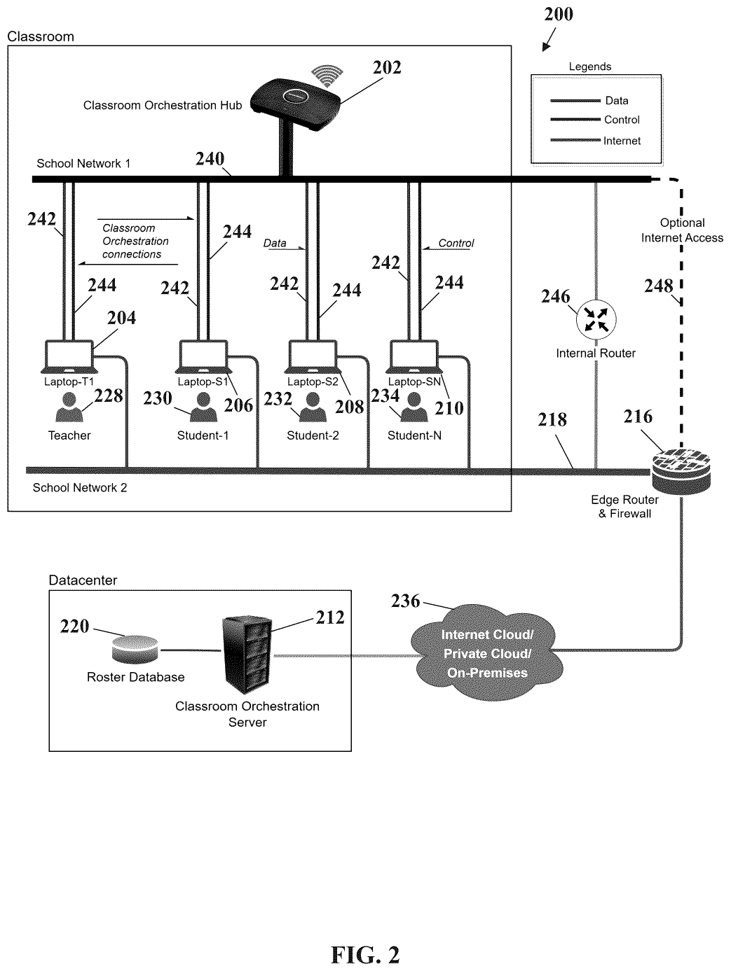

Referring now to FIG. 2, an example deployment of a collaborative system is illustrated. As shown in FIG. 2, and in brief overview, system 200 may include hub device 202, moderator device 204, participant device 206, participant device 208 through participant device 210, server 212, and/or router 216. Users of system 200 may include moderator 228 (via moderator device 204), participant 230 (via participant device 206), and/or participant 232 through participant 234 (via participant device 208 through participant 210). It will be understood that system 200 may be the same as or similar to system 100 of FIG. 1 or may be any other collaborative system in accordance with the principles of the present invention. Similarly, the various components or software of system 200 may be the same as or similar to components or software described with respect to system 100 of FIG. 1 or may be any other components or software. For example, hub device 202, moderator device 204, and/or participant device 206 may be the same as or similar to, respectively, hub device 102, moderator device 104, and/or participant device 106 of system 100 or may be any other type(s) of computing devices.

Various components of system 200 may be connected to one another via one or more network connections. For example, moderator device 204, participant device 206, and/or participant device 208 through participant device 210 may generally connect to network 118 within a collaborative setting using a single sign-on (SSO) process via Wi-Fi or another wired or wireless network connection. Connecting to network 218 may provide moderator 228, participant 230, and/or participant 232 through participant 234 with access to various IT services such as email, shared data storage, etc., as well as the internet, via their respective devices.

Moderator software installed on moderator device 204 and/or participant software installed on participant device 206 and/or participant device 208 through participant device 210 may connect to server 212, which may be hosted on cloud 236 (e.g., an internet or private cloud) or physically located on- or off-premises, via router 216. Moderator device 204, participant device 206, and/or participant device 208 through participant device 210 may maintain their respective connections to server 212 for as long as the respective devices remain connected to and authenticated on network 218.

Network 240 may be reserved for connecting to hub device 202 for purposes of collaboration within the collaborative setting. Should an application within a suite of hub software installed on hub device 202 require internet access for execution, network 240 may need to be routed to router 216 via internet access 248. Router 216 may be an edge router and firewall device or any other router.

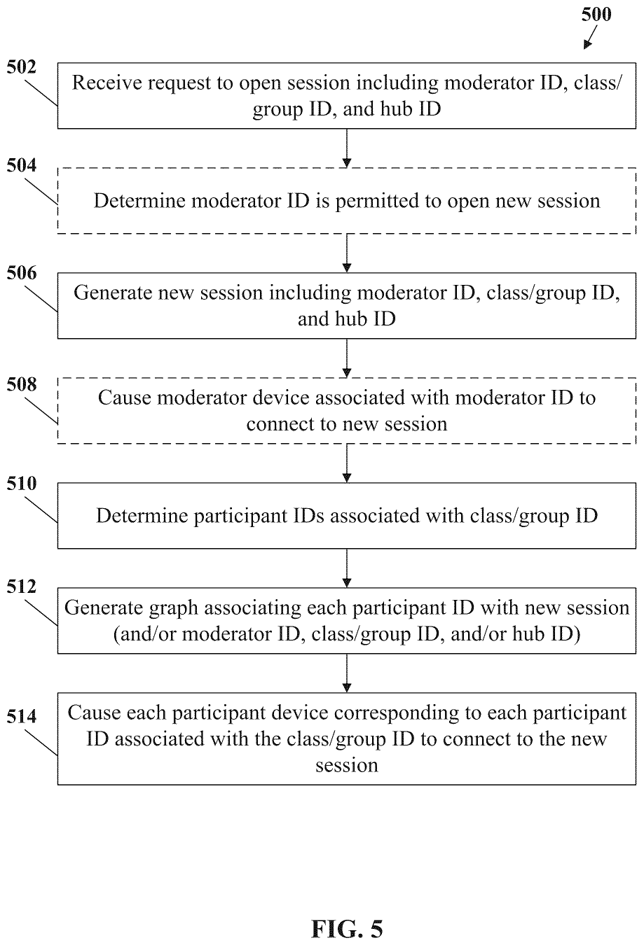

Hub device 202 may connect to network 240, for example, via Ethernet or Wi-Fi connection. In the absence of a moderator such as moderator 228 having initiated a collaboration session via moderator device 204, hub device 202 may remain idle. When moderator 228 instructs moderator device 204 to connect to hub device 202 in order to start a collaboration session, an auto-connect protocol (further described below with respect to FIG. 5) may initiate, which may refer to roster data stored in roster database 220 on server 212. The auto-connect protocol may cause the respective devices of all participants on a roster corresponding to moderator 228 (e.g., participant 230 and/or participant 232 through participant 234) to connect to hub device 202 along with moderator device 204. Accordingly, moderator device 204 as well as participant device 206 and/or participant device 208 through 210 may each initiate a collaboration connection, thereby establishing data connection 242 and/or control connection 244 for communication of, respectively, data and control messages with hub 202. Data connection 242 and/or control connection 244 may only remain active until moderator 228 terminates the collaboration session.

An IT administrator for the collaborative setting may need to ensure that hub device 202 on network 240 is accessible by each of moderator device 204, participant device 206, and/or participant device 208 through participant device 210 on network 218. For example, internal router 246 may facilitate communications between network 240 and network 218. Further, many collaborative technologies that may be integrated into system 200, including but not limited to wireless display technology (e.g., Miracast®, Apple® AirPlay®, or Google® Chromecast®) and/or interactive whiteboard technology, may require internet access to properly function. Network 240 may be routed to router 216 in order to provide internet access for such collaborative technologies.

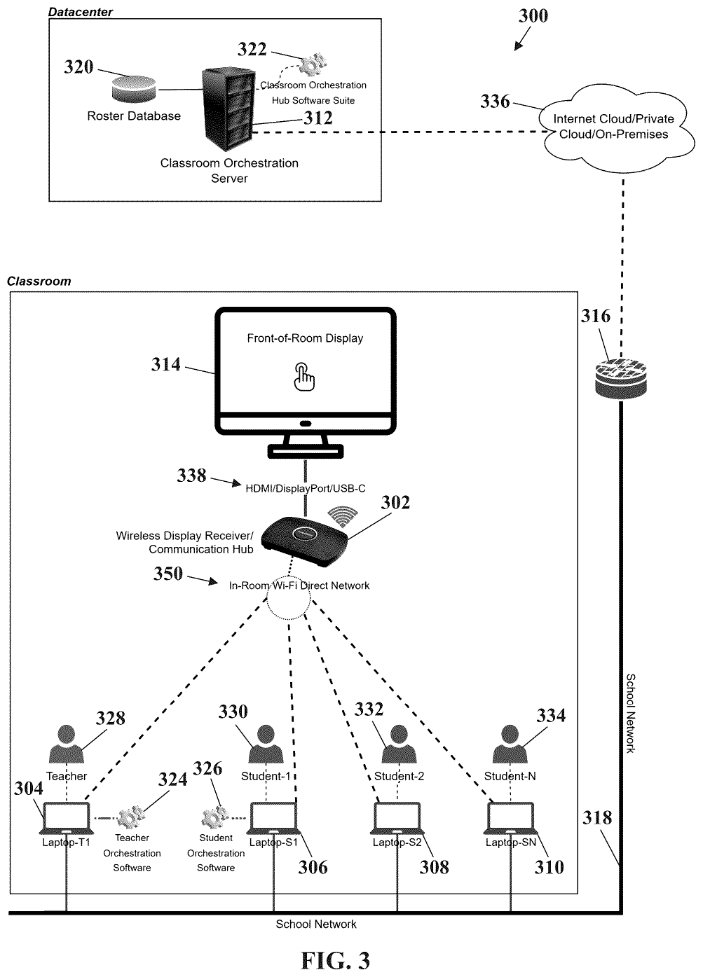

Referring now to FIG. 3, an example collaborative system employing an alternate system architecture is illustrated. As shown in FIG. 3, and in brief overview, system 300 may include hub device 302, moderator device 304, participant device 306, participant device 308 through participant device 310, server 312, display device 314, and/or router 316. Users of system 300 may include moderator 328 (via moderator device 304), participant 330 (via participant device 306), and/or participant 332 through participant 334 (via participant device 308 through participant 310). It will be understood that system 300 may be the same as or similar to system 100 of FIG. 1 or system 200 of FIG. 2 or may be any other collaborative system in accordance with the principles of the present invention. Similarly, the various components or software of system 300 may be the same as or similar to components or software described with respect to system 100 of FIG. 1 or system 200 of FIG. 2 or may be any other components or software. For example, hub device 302, moderator device 304, and/or participant device 306 may be the same as or similar to, respectively, hub device 102 and/or hub device 202, moderator device 104 and/or moderator device 204, and/or participant device 106 and/or participant device 206 of system 100 and/or system 200 or may be any other type(s) of computing devices.

Roster database 320, which may include roster data corresponding to any of moderator 328, participant 330, and/or participant 332 through participant 334, may be stored on server 312. Hub software 322, which may include a similar suite of programs or applications to hub software 122 and/or any number of other collaborative software programs or applications, may run on server 312. Server 312 may be deployed on cloud 336 (e.g., internet or private cloud) and/or may be physically located on- or off-premises with respect to the collaborative environment. Moderator software 324 may be locally installed on moderator device 304. Similarly, instances of participant software 326 may be locally installed on each of participant device 306 or participant device 308 through participant device 310. Moderator software 324 and/or participant software 326 may be compatible with hub software 322 to facilitate collaboration sessions within the collaborative setting.

In the case that server 312 is deployed on cloud 336, communication traffic between moderator device 304 and any of participant device 306 or participant device 308 through participant device 310 may need to be transmitted back and forth via the internet (e.g., via router 316 connected to network 318). This may introduce long network latency, which may degrade user experience. For example, were participant 330 to share media content from participant device 306 with moderator 328 via moderator device 304, moderator 328 might experience significant audio and video lags in viewing the media content on moderator device 304.

This issue of high traffic and long latency may be addressed by adding hub device 302 to system 300 (e.g., connected to display device 314 via connection 338) in order to serve as a communication hub and/or provide wireless display functionality. Hub device may host software from server 312 and/or communicate with various client software programs or applications that run on moderator device 304, participant device 306, and/or participant device 308 through participant device 310. Hub device 302 may be capable of creating a local Wi-Fi Direct® network (e.g., Wi-Fi Direct® network 350), which any of moderator device 304, participant device 306, and/or participant device 308 through participant device 310 may be able to join. As such, hub device 302 may provide for Wi-Fi Direct® network 350 to pass data traffic between moderator device 304 and any of participant device 306 and/or participant device 308 through participant device 310. Accordingly, the data traffic load on network 318 may be reduced, which may thereby reduce network latency and enhance user experience as a result. If system 300 is initially deployed in a collaborative setting without hub device 302, hub device 302 may be added at any later time in order to improve network efficiency and reduce network latency.

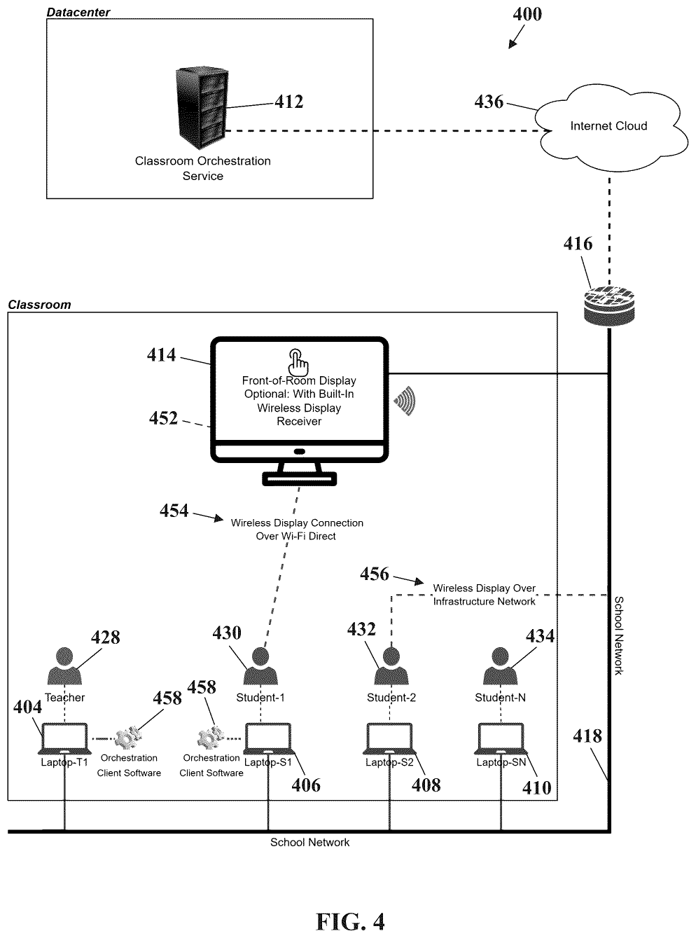

Referring now to FIG. 4, an example deployment of a collaborative system without a hub device (i.e., employing software-only architecture) is illustrated. As shown in FIG. 4, and in brief overview, system 400 may include moderator device 404, participant device 406, participant device 408 through participant device 410, server 412, display device 414, and/or router 416. Users of system 400 may include moderator 428 (via moderator device 404), participant 430 (via participant device 406), and/or participant 432 through participant 434 (via participant device 408 through participant 410). It will be understood that system 400 may be the same as or similar to system 100 of FIG. 1, system 200 of FIG. 2, or system 300 of FIG. 3 or may be any other collaborative system in accordance with the principles of the present invention. Similarly, the various components or software of system 400 may be the same as or similar to components or software described with respect to system 100 of FIG. 1, system 200 of FIG. 2, or system 300 of FIG. 3 or may be any other components or software. For example, moderator device 404, participant device 406, and/or server 412 may be the same as or similar to, respectively, moderator device 104, moderator device 204, and/or moderator device 304, participant device 106, participant device 206, and/or participant device 306, and/or server 112, server 212, and/or server 312 of system 100, system 200, and/or system 300 or may be any other type(s) of computing devices.

Each of moderator device 404, participant 406, and/or participant device 408 through participant device 410 may run an instance of client software 458, which may require connection to a collaboration service located on server 412 and accessible via cloud 436. Such a system architecture may offer simple deployment for users because no additional hardware devices or changes to the configuration of network 418 are required.

This system architecture may, however, result in greater network latency in data communications between moderator device 404, participant 406, and/or participant device 408 through participant device 410 due to all data traffic requiring transmission to the internet and back to a respective device. Such latency may result in an undesirable user experience for moderator 428, participant 430, and/or participant 432 through participant 434, particularly with respect to screen-sharing and other collaborative applications.

Further, without a standalone wireless display receiver connected to display device 414, screen-sharing may only be possible on moderator device 404, participant device 406, and/or participant device 408 through participant device 410. As such, use of display device 414 may not be optimized during a collaboration session.

In order to address these and other issues, display device 414 may be a “smart” display device including a built-in wireless display receiver (e.g., wireless display receiver 452). Wireless display receiver 452 may provide for the sharing of media content generated by moderator device 404, participant device 406, and/or participant device 408 through participant device 410 on display device 414 via wireless display connection 454 over Wi-Fi Direct® and/or wireless display connection 456 over infrastructure network 418.

In addition to the functionality of wireless display receiver 452, display device 414 may further include an integral device or functionality similar, for instance, to hub device 102 of system 100, hub device 202 of system 200, and/or hub device 302 of system 300 or their respective functionalities. Accordingly, display device 414 may serve as a hub device within system 400 and offer corresponding functionality for managing collaborative technology.

Referring now to FIG. 5, process 500 illustrates example steps for automatically connecting one or more participant devices to a collaborative software platform in accordance with principles of the present invention. It will be understood that any of the devices, components, or software applications associated with the collaborative software platform may be the same as or similar to any of the devices, components, or software applications of any system described or otherwise envisioned herein (e.g., system 100 of FIG. 1, system 200 of FIG. 2, system 300 of FIG. 3, and/or system 400 of FIG. 4) or may be any other devices, components, or software applications. For example, any of the steps described herein may be performed by a computing device such as any one (or more) of the various hub devices or servers described with respect to any of system 100, system 200, system 300, or system 400 (or any other collaborative system) and/or may be performed via execution of software, for instance, over any of the internet or private clouds described with respect to any of the aforementioned systems (or any other collaborative system). As another example, the moderator device associated with various steps in process 500 may be the same as or similar to any of moderator device 104 of system 100, moderator device 204 of system 200, moderator device 304 of system 300, or moderator device 404 of system 400 or may be any other moderator device.

A collaborative software platform may only require that a moderator but not participants actively connect to a hub device and/or a collaboration session associated with the collaborative software platform. Once the moderator has connected to the collaborative software platform (e.g., by connecting a moderator device to a hub device of a collaborative system), the associated system may invoke the auto-connect protocol for participants (e.g. “participant follow moderator connect”) to automatically connect all participants on a roster that belongs to a moderator to the same hub device as the moderator device and/or to automatically join the collaboration session once initiated.

The auto-connect protocol may owe its functionality to a connection that exists between the moderator device and each participant device to a server of the collaborative system (which may, for example, be physically located on-premises or exist on an internet cloud). Using a roster database, the server may generate a graph for the roster belonging to the moderator that relates the moderator to all participants included on the roster (e.g., a teacher's class section including all students enrolled in that section). When the moderator starts a collaboration session, the collaborative software platform may refer to the graph and send instructions to each participant device corresponding to a participant included on the roster to connect to the same hub device as the moderator device.

The auto-connect protocol sequence may function as follows: The moderator may launch moderator software installed on his or her corresponding moderator device and use a “connect” UI to select the roster from a pull-down list. The moderator may enter the name of the hub device located in the collaborative setting (e.g., the name displayed on a “ready-to-connect” screen of hub software installed on the hub device). The moderator software may connect to the hub software; accordingly, the moderator device may be connected to the hub device. After connecting to the hub software, the moderator software may send instructions to the server to announce that a new collaboration session is open for the appropriate moderator, roster, and/or hub device (or software). The server may generate a graph that links the moderator to any participants included on the roster. The graph may map each participant to a corresponding instance of participant software running on each participant's respective participant device. The server may traverse the graph and, for each participant node identified on the graph, send instructions to the corresponding instance of participant software to connect to the hub software. The participant software may, for example, identify an internet protocol (IP) address corresponding to the hub software (or device) by name and connect to the IP address. Accordingly, shortly after the moderator has connected his or her moderator device to the hub device, the participant devices corresponding to all participants belonging to the moderator's roster may have automatically connected to the hub device, as well-no participant intervention required. With the moderator device and all appropriate participant devices connected to the hub device, the moderator software installed on the moderator device may transmit instructions to and collect data from each instance of participant software corresponding to a connected participant device.

For example, as shown in FIG. 5, at step 502, a request may be received, as part of an auto-connect process, to open a session within a collaborative software platform environment. The request may, for instance, be received by a computing device (e.g., a server) in communication with, connected to, or otherwise associated with one or more modules of a collaborative software platform. The request may be transmitted by moderator software, which may be installed on a moderator device. The moderator software and/or moderator device may be associated with a moderator ID corresponding to a moderator (e.g., a teacher). The request may further be associated with a class or group ID and/or a hub ID. The class or group ID may correspond to a class or group of participants (e.g., students) associated with the moderator. The hub ID may correspond to a hub device and/or software through which the session is to be orchestrated.

At step 504, a determination may be made as to whether the moderator corresponding to the moderator ID is permitted to open a new session within the collaborative software platform. If the moderator is permitted to open the new session, at step 506, the new session may be generated and may be identified by the moderator ID, the class or group ID, and/or the hub ID. At step 508, the moderator software and/or device associated with the moderator ID may be caused to connect to the new session (e.g., by the server or other computing device). As such, the server or other computing device may recognize that the moderator is connected to the new session identified by the moderator ID, the class or group ID, and/or the hub ID.

At step 510, one or more participant IDs corresponding to one or more participants and/or participant devices and associated with the class or group ID may be determined (e.g., by the server or other computing device). At step 512, the server or other computing device may generate a graph associating each participant ID with the new session identified by the moderator ID, the class or group ID, and/or the hub ID. At step 514, the server or other computing device may cause each participant device corresponding to each participant ID associated with the class or group ID to connect to the new session being moderated by the moderator (e.g., via communication with participant software installed on each such participant device). Accordingly, the moderator software may be able to send commands to and/or collect data from each instance of participant software for the duration of the new session.

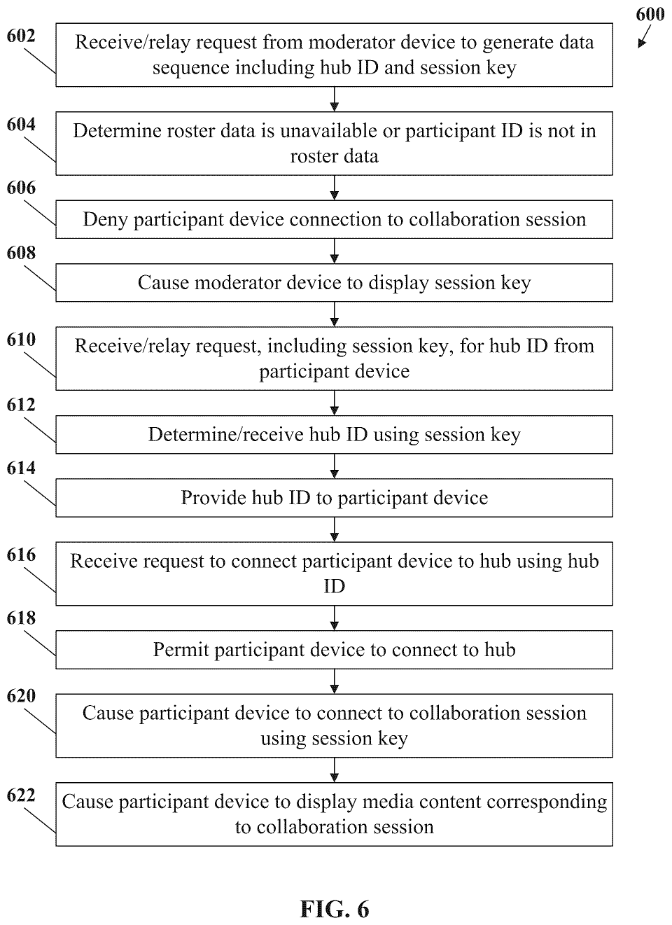

Referring now to FIG. 6, process 600 illustrates example steps for manually connecting to a collaborative software platform in accordance with principles of the present invention. As with respect to FIG. 5, it will be understood that any of the devices, components, or software applications associated with the collaborative software platform may be the same as or similar to any of the devices, components, or software applications of any system described or otherwise envisioned herein (e.g., system 100 of FIG. 1, system 200 of FIG. 2, system 300 of FIG. 3, and/or system 400 of FIG. 4) or may be any other devices, components, or software applications.

In some cases, a participant device may be denied connection to a collaboration session if a participant identifier corresponding to the participant device is not amongst participant IDs included in roster data that may be determined or received by a computing device. In such a case, process 600 describes example steps for connecting the participant device to the collaboration session on an “ad-hoc” basis. It will be understood that various steps of process 600 may be performed by one or more computing devices. For example, the computing device may be a hub device or a server connected to the collaborative system. Depending on the particular configuration of the collaborative system, certain steps may be performed by the hub device, while others may be performed by the server. For example, when the collaborative system employs a software-only architecture, all steps may be performed on the server via communication over the cloud. Alternatively, when the collaborative system includes a hub device, the hub device may perform certain steps individually or in communication with the server.

As shown in FIG. 6, and in brief overview, at step 602, a computing device receives and/or relays a request from a moderator device to generate a tuple including a hub identifier (e.g., a hub name) and a session key (e.g., a randomly-generated four-character alphanumerical code). For example, the session key may be generated by the moderator software when the moderator device is connected to the computing device. The session key may correspond to the hub identifier. Each time the moderator device initiates a new collaboration session in connection with the computing device, a new session key may be generated. As such, each tuple entry may overwrite a preceding entry using the new session key in place of the old session key with a constant from entry to entry being the hub identifier.

At step 604, the computing device may determine that roster data is unable or that a participant identifier corresponding to a participant device is not included in the roster data from a roster database stored on a server or other computing device of the collaborative system. At step 606, the participant device may be denied connection to the collaboration session initiated by the moderator device due to the roster data being empty or the participant identifier otherwise not being included in the roster data.

At step 608, the moderator device may be caused to display the session key for reference purposes. The session key may be provided by the moderator to the participant using the participant device so that the participant may enter the session key in a corresponding instance of the participant software. At step 610, the computing device may receive (e.g., server) or relay (e.g., hub device) a request, including the session key, from the participant device to resolve the hub identifier by locating the (active) tuple generated at step 602. At step 612, the computing device may determine (e.g., server) or receive (e.g., hub device) the hub identifier by using the session key to locate the corresponding tuple. At step 614, the hub identifier may be provided to the participant device. At step 616, the computing device may receive a request to connect the participant device to the hub (e.g., the hub device or a software-only implementation executed on the cloud-based server) using the hub identifier. For example, the participant device may generate an IP address from the hub identifier and may transmit a request to connect to the corresponding hub to the computing device. The computing device may grant the request, thereby positioning the participant device as if the corresponding participant had been included in the active roster all along. Once connected to the hub, the participant device may be connected to the collaboration session via an auto-connect protocol, much like other participant devices whose corresponding participants were already listed on the active roster.

At step 620, for example, the computing device may cause the participant device to connect to the collaboration session using the session key. At step 622, the computing device may cause the participant device to display media content corresponding to the collaboration session.

As an example implementation of process 600, a student (i.e., a participant) may be added to a roster for a class taught by a teacher (i.e., a moderator) within a collaborative setting on an ad-hoc basis. Adding the student to the roster in such a manner may be required where the roster database stored on the server is down (i.e., the roster is empty), the teacher offers a lecture outside of the regular class (i.e., the roster is empty), or a new student enrolls in the class but his or her information has not yet been entered into the roster database (i.e., the roster is incomplete). When the roster is empty or incomplete, students not on the roster may not be able to automatically connect to a hub device or hub software (e.g., a classroom orchestration hub) to which the teacher is connected. Instead, any such student may need to join the roster on an ad-hoc basis, which may be accomplished as follows:

When the teacher connects to the classroom orchestration hub, the moderator software (e.g., teacher classroom orchestration software) may generate a random four-character alphanumerical code as a session ID of an active corresponding collaboration session. The teacher classroom orchestration software may call an API provided by a server of the collaborative system, which may enter a tuple (e.g., {hub name, session ID}) in a list of currently-active classroom orchestration hubs. The hub name may be the name of the classroom orchestration hub as shown on the ready-to-connect screen shown on a front-of-room display. The latest tuple entry may overwrite a preceding entry in the currently-active hub list. When a student needs to join the class roster on an ad-hoc basis, the teacher may open a “session info” menu in the teacher classroom orchestration software, which may display relevant data including the four-character session ID. The teacher may instruct the student to open a “join roster ad-hoc” menu in the student's instance of participant software (e.g., student classroom orchestration software) and enter the session ID. A dialog may pop up and ask the student to enter the session ID. The student may comply. The student classroom orchestration software may use the session ID to query the server for the hub name that matches the given session ID. The server may search its list of currently-active hubs and identify a match. The server may return the matching hub name to the student classroom orchestration software. The student classroom orchestration software may resolve the hub name into an IP address and may proceed to connect to the classroom orchestration hub at the IP address.

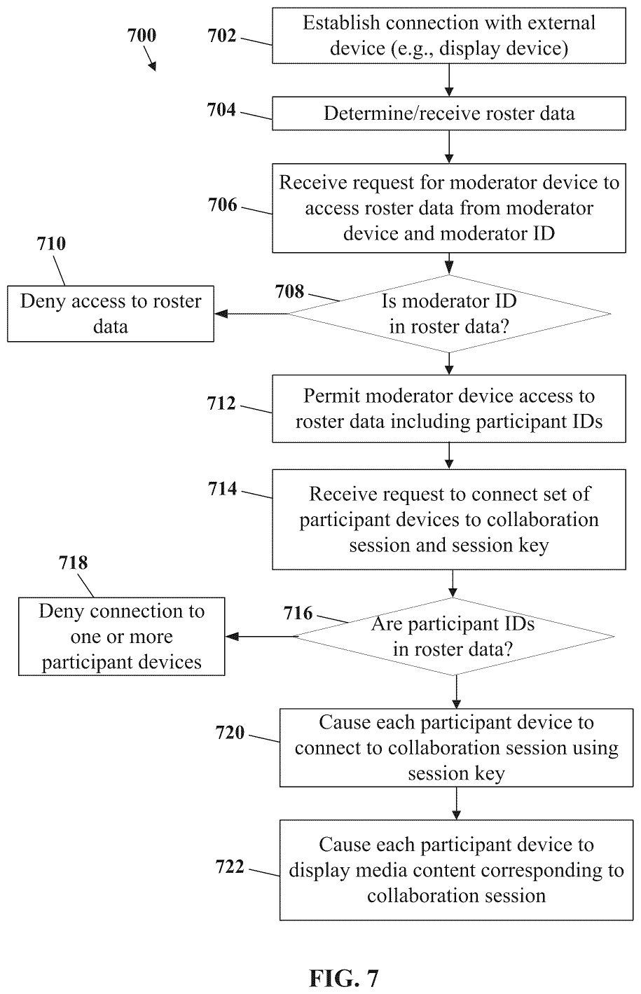

Referring now to FIG. 7, process 700 illustrates example steps for automating connection to a collaboration session in accordance with principles of the present invention. Similarly to FIG. 5 and FIG. 6, it will be understood that any of the devices, components, or software applications associated with the collaboration session and/or a compatible collaborative software platform may be the same as or similar to any of the devices, components, or software applications of any system described or otherwise envisioned herein (e.g., system 100 of FIG. 1, system 200 of FIG. 2, system 300 of FIG. 3, and/or system 400 of FIG. 4) or may be any other devices, components, or software applications. In one example, the collaboration session may be supported by a collaboration software platform or a secondary software platform alone or together with the collaboration software platform.

As shown in FIG. 7, and in brief overview, at step 702, a connection may be established between a computing device and an external device (e.g., a display device). The computing device may be a hub device (e.g., external or integral to the display device), a server, or any other computing device that may be connected to the display device by wired or wireless connection. At step 704, roster data may be determined or received by the computing device (e.g., from a roster database stored on a server). The roster data may, for example, be associated with a moderator identifier corresponding to a moderator (e.g., a teacher) and may include any number of participant identifiers corresponding to as many participants (e.g., students). At step 706, the computing device may receive, from a moderator device, a request for the moderator device to access the roster data. The request may include another moderator identifier corresponding to the moderator device. At step 708, the computing device may determine whether the moderator identifier included in the request from the moderator device corresponds to the moderator identifier associated with the roster data. If the two moderator identifiers are not the same, at step 710, the computing device may deny the moderator device access to the roster data. Conversely, if the two moderator identifiers are the same, at step 712, the computing device may permit the moderator device access to the roster data including the participant identifiers. At step 714, the computing device may receive a request to connect a set of participant devices corresponding to a set of participant identifiers to a collaboration session associated with a collaborative software platform, as well as a session key corresponding to the collaboration session. The moderator device and the display device may be connected to the collaboration session and may each display media content corresponding to the collaboration session. The collaboration session may be moderated by the moderator via the moderator device. The display device. At step 716, the computing device may determine whether the set of participant identifiers corresponds to the participant identifiers included in the roster data. If any of the set of participant identifiers corresponding to the set of participant devices are not included in the roster data, at step 718, the computing device may deny the request to connect the participant device(s) not corresponding to any participant identifier included in the roster data. For each participant device corresponding to a participant identifier included in the roster data, at step 720, the computing device may cause the respective participant device to connect to the collaboration session using the session key. At step 722, the computing device may cause each participant device connected to the collaboration session to display the media content corresponding to the collaboration session. Process 700 may be associated with an auto-connect protocol of a collaborative system and/or collaborative software platform, such as the auto-connect process described above with respect to FIG. 5.

The moderator device and/or participant devices may be granted varying access to the collaboration system. The moderator device may be permitted moderator access to the collaboration session and each participant device of the set of participant devices may be permitted access to the collaboration session upon determining that the moderator identifier and each respective participant identifier are included in the roster data. The moderator may manipulate a participant device's access and/or functionality with respect to the collaboration session. For example, a request to modify at least one restriction associated with the participant's access to the collaboration session may be received from the moderator device.

In one example, the participant device may generate a portion of media content and the moderator device may be caused to display the portion of the media content. Additionally, or alternatively, the display device may also be caused to display the portion of media content.

The moderator device may request to connect additional participant devices to the collaboration session. In one example, the additional participant devices may not be included in the roster data. In response to the request from the moderator device, each additional participant device may be provided a session key (e.g., from the moderator device), and caused to connect to the collaboration session using the session key. The roster data may be updated to include the participant identifiers corresponding to the newly added participant devices. In one example, the roster data may be provided to the computing device from a server. Once joined to the collaboration session, each additional participant device may be caused to display media content displayed by the display device and/or the moderator device.

The participant devices may be caused to connect to the collaboration session using the session key by, for example, transmitting a request to execute a software application installed on each participant device and causing each participant device to execute the software application using the session key.

The moderator device may terminate a collaboration session by disconnecting from the collaboration session. Upon detecting a disconnect of moderator device from the collaboration session, the participant devices may be caused to also disconnect from the collaboration session.

It may be desirable to remove personal identifier information relating to the moderator devices and/or participant devices. For example, prior to receiving the roster data associated with one or more moderator identifier and including the participant identifiers, personal information associated with a moderator and/or participants corresponding, respectively, to the first moderator identifier and the plurality of participant identifiers may be removed.

The following additional use cases illustrate how a collaborative system in accordance with the principles of the present invention may be implemented in an example collaborative setting, namely, a class taught by a teacher (i.e., moderator) and in which a number of students (i.e., participants) are enrolled. The teacher and students may each have their own computing device (e.g., a laptop, tablet, or desktop computer) on which an instance of collaborative software (i.e., moderator software or participant software, hereinafter referred to, respectively, as teacher classroom orchestration software or student classroom orchestration software) may be installed. These use cases highlight the seamless user experience for teachers and students that is made possible by the tight integration of disparate educational and collaborative technologies (e.g., wireless display technology, interactive or collaborative whiteboard technology, and/or classroom management technology) through a hub device and/or hub software of a collaborative system.

Because the teacher and students in the example class may all be connected to the hub device and/or hub software, the collaborative system may automate, for the teacher, many otherwise tedious and time-consuming administrative, “housekeeping,” or logistical tasks involved in using the various educational or collaborative technologies with the class. Such automation may be accomplished by the teacher classroom orchestration software sending commands to each instance of the student classroom orchestration software via the hub device and/or hub software (hereinafter collectively referred to as the classroom orchestration hub) to trigger actions in the students' respective laptops or tablets without any need for student intervention. It will be understood that each use case that follows is for illustrative purposes only and is in no way meant to limit the scope of the present disclosure, as numerous other embodiments of collaborative systems and methods in accordance with principles of the present invention are envisioned by this disclosure.

In a first use case, for example, a collaborative system may integrate collaborative whiteboard technology. With the classroom orchestration hub, the teacher may only need to initiate a collaboration session involving the collaborative whiteboard technology, while the students may not need to do anything. Momentarily, both the teacher and the students may be joining the collaboration whiteboard session, with the whiteboard view being shown on the display device located at the front of the room. This process may be compared with the number of steps that the teacher and the students would need to perform to achieve the same end result without the classroom orchestration hub: The teacher would first need to create a collaborative whiteboard session, taking note of the session's URL. Next, the teacher would need to send the URL to the students, for example, using a chat tool. The teacher would then need to launch a wireless display session to show the whiteboard view from the teacher's laptop, tablet, or desktop computer on the front-of-room display. Finally, the students would all need to manually launch the collaborative whiteboard application and enter the session URL provided by the teacher. At this point, the teacher might need to assist students having difficulty joining the collaborative whiteboard session, thereby wasting valuable class time away from teaching any lesson.

Where the class does have access to the collaborative system involving the classroom orchestration hub, the complex tasks associated with creating a collaborative whiteboard session for the teacher and his or her students may be simplified. As preconditions for this use case, the teacher may have already connected to a classroom orchestration hub and started a collaboration session. All students on the teacher's roster for the given class may be connected to the same classroom orchestration hub. The collaborative whiteboard service may be supported by or integrated into the collaborative system.

The teacher may use the GUI of the teacher classroom orchestration software to create a collaborative whiteboard session. The teacher classroom orchestration software may use an appropriate API to create a new session with the collaborative whiteboard service. A session URL may be returned to the teacher classroom orchestration software. The teacher classroom orchestration software may automatically launch the collaborative whiteboard application on the teacher's computer with the session URL. A collaborative whiteboard view may be displayed on the teacher's computer. The teacher may open a “student roster” menu on the teacher classroom orchestration software and select one or a group of students to join the collaborative whiteboard session. The teacher classroom orchestration software may send a command for the students to join the collaborative whiteboard session to the classroom orchestration hub. The command may include a list of the selected students and the session URL. The classroom orchestration hub may forward the command to join the collaborative whiteboard session (with the session URL) to each instance of the student classroom orchestration software corresponding to a student on the list of selected students. Each such instance of the student classroom orchestration software may automatically launch the collaborative whiteboard application using the given session URL. Each corresponding student's computer may display the same collaborative whiteboard view that displays on the teacher's computer.

In a second use case, the teacher may select one or more students for direct screen-sharing on the front-of-room display. This use case illustrates how the teacher may maintain control over which student or group of students can directly share the screen(s) of their respective computer(s) on the front-of-room display, for example, using wireless display technology. By default, during a collaboration session, the classroom orchestration hub may only allow the teacher to screen-share via wireless display, whereas students may only be allowed to perform wireless display subject to the teacher's permission. As preconditions for this use case, the teacher may have already connected to a classroom orchestration hub and started a collaboration session. All students on the teacher's roster for the given class may be connected to the same classroom orchestration hub. The classroom orchestration hub may support standard wireless display technologies (e.g., Miracast®, Infracast, AirPlay®, Chromecast®, and/or WebRTC). In the event that proprietary wireless display technology may be deployed, such proprietary technology may be supported by the classroom orchestration hub.

In a “single-view” mode, the teacher may open the student roster menu in the teacher classroom orchestration software. The teacher may select a student to share his or her screen by wireless display. The teacher classroom orchestration software may send a command to initiate wireless display, along with a student identifier corresponding to the selected student, to the classroom orchestration hub. The hub may prepare to unlock wireless display for the student identifier and forward the command to the selected student's instance of the student classroom orchestration software. The selected student's instance of the student classroom orchestration software may automatically initiate a wireless display session on the classroom orchestration hub without requiring the student to intervene. The selected student's screen may be displayed on the front-of-room display.

The classroom orchestration hub may also support a “multi-view” mode. In multi-view mode, multiple sources may concurrently perform wireless display on the classroom orchestration hub. The classroom orchestration hub may display media content from each such source in a small window on the front-of-room display. When multi-view mode is deployed, the teacher may select multiple students to share their respective screens. The corresponding sequence of events may be similar as when selecting just one student for screen-sharing, except that the teacher classroom orchestration software may send a series of commands to initiate wireless display to the classroom orchestration hub. The classroom orchestration hub may forward the commands to each selected instance of the student classroom orchestration software. Once wireless display has been initiated, the classroom orchestration hub may display each selected student's computer screen in a small window on the front-of-room display. The teacher may also his or her own computer screen on the front-of-room display at the same time with one or more students. In this case, the teacher classroom orchestration software may simply initiate a wireless display connection to the classroom orchestration hub. The classroom orchestration hub may display the teacher's screen in a small window on the front-of-room display.

If the front-of-room display is touch-capable, and of the respective computers of the teacher and the students are ink-enabled, this use case may be extended to support inking. With a wireless display such as Miracast® that supports user input back channel (UIBC), touch actions performed on the touch display (which may be connected to the classroom orchestration hub, for instance, by USB cable) may also be sent to the respective source computer.

With inking enabled in single-view mode, a student may be working, for example, on a slideshow presentation (e.g., Microsoft® PowerPoint presentation). Inking may be enabled on the student's computer. The student may wish to present his or her work to the class. The teacher may select the student in the roster for screen-sharing by wireless display (e.g., Miracast®). The student's slideshow presentation may be shown on the front-of-room display. The student may annotate his or her slideshow presentation using the inking feature on the student's computer. The ink annotations may be shown on the student's computer, as well as the front-of-room display due to wireless display. The teacher may annotate the slideshow presentation at the front-of-room display. Through UIBC, the touch events may be sent to the student's computer, where they are rendered into ink traces on the slideshow presentation. The student's computer will show the teacher's annotations on the slideshow presentation. The annotations may also be shown on the front-of-room display due to wireless display. Accordingly, in single-view mode, inking may work in both directions, or, annotations made using the front-of-room display may be mirrored on the source computer, while annotations made on the source computer may be mirrored on the front-of-room display.

With inking enabled in multi-view mode, a student may want to share his or her research results, which may be saved in a notes application (e.g., Microsoft® OneNote application), with the class. Inking may be enabled on the student's computer. The teacher may select the student in the roster for screen-sharing, for instance, via Miracast®. The student's notes application may be shown on the front-of-room display. The teacher may have a notes application document about the research topic to share with the class at the same time as the student is sharing her own research results. The teacher may use the teacher classroom orchestration software to project the teacher's computer screen via Miracast® to the front-of-room display. The classroom orchestration hub may display each of the student's screen and the teacher's screen in multi-view mode. For example, the student's screen may be displayed in the left-side half of the front-of-room display, while the teacher's screen may be displayed in the right-side half of the front-of-room display. The student may annotate his or her notes document using the inking feature on the student's computer. The ink annotations may be shown on the student's laptop, as well as the front-of-room display due to wireless display. The teacher may annotate the student's notes document at the front-of-room display. Through UIBC, the touch events may be sent to the student's computer, where they may be rendered into ink traces on the notes document. The student's computer may show the teacher's annotation on the notes document. The annotations may also be shown on the left-side half of the front-of-room display due to wireless display. The teacher may move to his or her desk and annotate his or her notes document on the teacher's computer. These annotations may be rendered into ink traces on the teacher's laptop and may also be shown on the right-side half of the front-of-room display due to wireless display. Accordingly, in multi-view mode, inking may work in both directions, or, annotations made on a multi-view window on the front-of-room display may be mirrored on the appropriate source computer, while any annotations made on the source computer may be mirrored on the corresponding multi-view window on the front-of-room display.

In a third use case, the teacher may select a student for monitored screen-sharing on the front-of-room display. This use case illustrates how the teacher may monitor the contents of a student's screen before allowing the student to show the content on the front-of-room display. This mode may be referred to as “monitored screen-sharing” mode. In monitored screen-sharing mode, the contents of the student's screen may be sent to the teacher's computer and then, at the teacher's discretion, displayed on the front-of-room display. By default, during a collaboration session, the classroom orchestration hub may only allow the teacher to utilize wireless display, whereas students may only be allowed to utilize wireless display subject to the teacher's discretion. As preconditions for this use case, the teacher may have already connected to a classroom orchestration hub and started a collaboration session. All students on the teacher's class roster may also be connected to the same classroom orchestration hub.

The teacher may open the roster menu in the teacher classroom orchestration software. The teacher may select a student for monitored screen-sharing. The teacher classroom orchestration software may send a command to initiate a monitored screen-sharing session including a student identifier corresponding to the selected student to the classroom orchestration hub. The classroom orchestration hub may forward the command to the selected student's computer. The instance of the student classroom orchestration software on the student's laptop may initiate a monitored wireless display session with the classroom orchestration hub. This may be a regular wireless display session except that, instead of showing the student's screen contents on the front-of-room display, the classroom orchestration hub may forward the corresponding media contents (e.g., audio and video streams) to the teacher classroom orchestration software. The classroom orchestration hub may show an appropriate screen on the front-of-room display. The teacher classroom orchestration software may open a window to display the student's screen contents. The teacher may monitor the student's contents for a short time, then decide to show the contents to the class on the front-of-room display. The teacher may use the GUI of the teacher classroom orchestration software to show the monitored contents on the front-of-room display. The teacher classroom orchestration software may sent a command to the classroom orchestration hub to show the student's screen contents on the front-of-room display. The classroom orchestration hub may play the student's audio and video streams on the front-of-room display and may continue to duplicate the streams and forward them to the teacher classroom orchestration software. The student may update his or her screen contents. The new screen contents may be shown on the front-of-room display due to wireless display. The new screen contents may also be shown on the monitored screen contents window in the teacher classroom orchestration software due to the classroom orchestration hub duplicating the student's screen contents (e.g., audio and video streams) in real-time and forwarding the contents to the teacher classroom orchestration software.

If the front-of-room display is touch-capable, and if each of the teacher's computer and the students' computers are ink-enabled, this use case may be extended to support inking. If inking is enabled on the teacher's laptop, when creating the monitored screen-sharing session, the classroom orchestration hub may create a new connection with the teacher classroom orchestration software to relay the touch events generated on the teacher's laptop to the classroom orchestration hub. This may be referred to as a UIBC-relay channel. The teacher may be located at his or her desk and may annotate the student's screen contents in the monitored screen-sharing window in the teacher classroom orchestration software. The teacher classroom orchestration software may capture the touch events and send them to the classroom orchestration hub in the UIBC-relay channel. The classroom orchestration hub may forward the touch events to the student's computer on a regular wireless display UIBC channel. The touch events from the teacher may be processed as regular UIBC events. The touch events may be rendered into ink traces, and the ink may be shown on the student's screen contents. Due to wireless display, the ink traces may be shown on the front-of-room display. Due to the classroom orchestration hub duplicating the student's wireless display audio and video streams and forwarding the streams to the teacher classroom orchestration software, the new ink traces may be shown in the monitored screen-sharing window on the teacher's computer. The student may annotate his or her screen contents. The annotations may be converted into ink traces on the student's computer. Due to wireless display, the new ink traces may be shown on the front-of-room display. Due to the classroom orchestration hub duplicating the student's wireless display audio and video streams and forwarding the streams to the teacher's computer, the new ink traces may be shown on the teacher's computer.

The teacher may ask another student to annotate the first student's contents at the front-of-room display. The second student may annotate on the front-of-room display, creating a flow of touch events that the classroom orchestration hub may send as UIBC events to the first student's computer. The first student's computer may convert the UIBC events into ink traces. The new ink traces may be displayed on the first student's computer and, due to wireless display, may be displayed on the front-of-room display. Due to the classroom orchestration hub duplicating the wireless display audio and video streams and forwarding the streams to the teacher classroom orchestration software, the new ink traces from the second student's annotations may be shown on the teacher's computer.

Accordingly, touch events on any touch-capable source, either the front-of-room display, the first student's computer, or the teacher's computer may be rendered into ink traces by the operating system of the first student's laptop, and the first student's screen contents may be updated across all connected devices (i.e., in the monitored screen-sharing window on the teacher's computer, on the front-of-room display, and on the first student's computer).

While specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment. It should further be understood that any of the computer operations described herein above may be implemented at least in part as computer-readable instructions stored on a computer-readable memory. It will, of course, be understood that the embodiments described herein are illustrative, and that components may be arranged, substituted, combined, and designed in a wide variety of different configurations, all of which are contemplated and fall within the scope of this disclosure.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments.

That which is claimed is:

1. A method for automating connection to a collaborative software platform, the method comprising:
establishing, by a computing device, a connection with a display device;
receiving roster data associated with at least one moderator identifier and comprising a plurality of participant identifiers, the at least one moderator identifier comprising a first moderator identifier;
receiving a first request to access the roster data from a moderator device, the first request comprising a second moderator identifier corresponding to the moderator device;
permitting the moderator device access to the roster data based on the first moderator identifier being the same as the second moderator identifier;
receiving, from the moderator device, a second request to connect a set of participant devices corresponding to a set of participant identifiers to a collaboration session on the collaborative software platform and a session key corresponding to the collaboration session;
determining the set of participant identifiers corresponds to the plurality of participant identifiers in the roster data;
causing each participant device of the set of participant devices corresponding to the set of participant identifiers to connect to the collaboration session using the session key; and
causing each participant device of the set of participant devices to display media content corresponding to the collaboration session on a respective participant device,
wherein the display device and the moderator device are connected to the collaboration session and each display the media content corresponding to the collaboration session.

2. The method of claim 1, further comprising:
permitting the moderator device moderator access to the collaboration session; and
permitting each participant device of the set of participant devices access to the collaboration session, the participant access granting, relative to the moderator access, restricted control of the collaboration session,
wherein displaying the media content on the display device is based at least in part on the moderator access and the participant access.

3. The method of claim 2, further comprising:
receiving, from the moderator device, a third request to modify at least one restriction associated with the participant access for at least a first participant device of the one or more participant devices connected to the collaboration session.

4. The method of claim 3, wherein at least a portion of the media content is generated by the first participant device, the method further comprising:
causing the moderator device to display the portion of the media content generated by the first participant device; and
causing the display device to display the portion of the media content generated by the first participant device.

5. The method of claim 1, further comprising:
receiving, from the moderator device, a third request to connect one or more additional participant devices to the collaboration session, the one or more additional participant devices not corresponding to the roster data;
causing each additional participant device of the one or more additional participant devices to connect to the collaboration session using the session key; and
causing each additional participant device of the one or more additional participant devices to display the media content corresponding to the collaboration session.

6. The method of claim 5, further comprising:
updating the roster data based on the third request to connect the one or more additional participant devices to the collaboration session.

7. The method of claim 5, wherein causing each participant device of the set of participant devices to connect to the collaboration session using the session key further comprises:
transmitting a fourth request to execute a software application installed on each participant device of the set of participant devices; and
causing each participant devices of the set of participant devices to execute the software application using the session key.

8. The method of claim 1, further comprising:
detecting a disconnection of the moderator device from the collaboration session; and
causing the set of participant devices to disconnect from the collaboration session based on detecting the disconnection of the moderator device from the collaboration session.

9. The method of claim 1, wherein the roster data is received from a server connected to the computing device.

10. The method of claim 1, further comprising:
removing, prior to receiving the roster data associated with the first moderator identifier and comprising the plurality of participant identifiers, personal information associated with a moderator and a plurality of participants corresponding, respectively, to the first moderator identifier and the plurality of participant identifiers.

11. A system for automating connection to a collaborative software platform, the system comprising:
memory configured to store computer-executable instructions; and
at least one computer processor configured to access memory and execute the computer-executable instructions to:
establish, by a computing device, a connection with a display device;
receive roster data associated with at least one moderator identifier and comprising a plurality of participant identifiers, the at least one moderator identifier comprising a first moderator identifier;
receive a first request to access the roster data from a moderator device, the first request comprising a second moderator identifier corresponding to the moderator device;
permit the moderator device access to the roster data based on the first moderator identifier being the same as the second moderator identifier;
receive, from the moderator device, a second request to connect a set of participant devices corresponding to a set of participant identifiers to a collaboration session on the collaborative software platform and a session key corresponding to the collaboration session;
determine the set of participant identifiers corresponds to the plurality of participant identifiers in the roster data;
cause each participant device of the set of participant devices corresponding to the set of participant identifiers to connect to the collaboration session using the session key; and
cause each participant device of the set of participant devices to display media content corresponding to the collaboration session on a respective participant device,
wherein the display device and the moderator device are connected to the collaboration session and each display the media content corresponding to the collaboration session.

12. The system of claim 11, wherein the at least one computer processor is further configured to access memory and execute the computer-executable instructions to:
permit the moderator device moderator access to the collaboration session; and
permit each participant device of the set of participant devices access to the collaboration session, the participant access granting, relative to the moderator access, restricted control of the collaboration session,
wherein displaying the media content on the display device is based at least in part on the moderator access and the participant access.

13. The system of claim 12, wherein the at least one computer processor is further configured to access memory and execute the computer-executable instructions to:
receive, from the moderator device, a third request to modify at least one restriction associated with the participant access for at least a first participant device of the one or more participant devices connected to the collaboration session.

14. The system of claim 13, wherein at least a portion of the media content is generated by the first participant device and wherein the at least one computer processor is further configured to access memory and execute the computer-executable instructions to:
cause the moderator device to display the portion of the media content generated by the first participant device; and
cause the display device to display the portion of the media content generated by the first participant device.

15. The system of claim 11, wherein the at least one computer processor is further configured to access memory and execute the computer-executable instructions to:
receive, from the moderator device, a third request to connect one or more additional participant devices to the collaboration session, the one or more additional participant devices not corresponding to the roster data;
cause each additional participant device of the one or more additional participant devices to connect to the collaboration session using the session key; and
cause each additional participant device of the one or more additional participant devices to display the media content corresponding to the collaboration session.

16. The system of claim 15, wherein the at least one computer processor is further configured to access memory and execute the computer-executable instructions to:
update the roster data based on the third request to connect the one or more additional participant devices to the collaboration session.

17. The system of claim 15, wherein causing each participant device of the set of participant devices to connect to the collaboration session using the session key further comprises:
transmitting a fourth request to execute a software application installed on each participant device of the set of participant devices; and
causing each participant devices of the set of participant devices to execute the software application using the session key.

18. The system of claim 11, wherein the at least one computer processor is further configured to access memory and execute the computer-executable instructions to:
detect a disconnection of the moderator device from the collaboration session; and
cause the set of participant devices to disconnect from the collaboration session based on detecting the disconnection of the moderator device from the collaboration session.

19. The system of claim 11, wherein the roster data is received from a server connected to the computing device.

20. The system of claim 11, wherein the at least one computer processor is further configured to access memory and execute the computer-executable instructions to:
remove, prior to receiving the roster data associated with the first moderator identifier and comprising the plurality of participant identifiers, personal information associated with a moderator and a plurality of participants corresponding, respectively, to the first moderator identifier and the plurality of participant identifiers.
